(19) United States
(12) Patent Application Publication
(10) Pub. No.: US 2007/0298189 A1
(43) Pub. Date: Dec. 27, 2007

(54) Plasma process for surface treatment of workpieces

(76) Inventors: Siegfried Straemke, Baesweiler (DE); Mark Straemke, Baesweiler (DE)

Correspondence Address: Vincent L. Ramik;Suite 101, 7345 McWhorter Place, Annandale, VA, 22003, US

(21) Appl. No.: 11/798,789

(22) Filed: May 17, 2007

(30) Foreign Application Priority Data
May 17, 2006 (DE) 10 2006 023 018.3

(51) Int. Cl. H05H 1/24

(52) U.S. Cl. 427/569

(57) ABSTRACT

In a pressure-tight reactor (10) a partial vacuum is generated in which a workpiece (13) is subjected to a plasma treatment. The pressure in a space (14) of said reactor (10) is periodically or aperiodically changed. Thus the surface layer of the workpiece (13) is rendered more uniform.

### RELATED FOREIGN APPLICATION

The present application claims the priority of German Patent Application No. 10 2006 023 018.3 the disclosure of which is herewith incorporated herein by reference.

### BACKGROUND OF THE INVENTION

1. Field of the Invention

The present invention relates to a plasma process for surface treatment of workpieces, wherein in a reactor a plasma discharge between an electrode and the workpiece takes place under partial vacuum conditions.

2. Description of Related Art

It is known to perform a workpiece surface treatment in plasma by diffusion and/or coating. These processes include, for example, plasma nitration, plasma carbonization, plasma boration, plasma oxidation and coating with substances for improving the surface qualities, such as wetting, heat conduction, corrosion, wear, friction behavior etc. The surface treatment can be performed by PVD (physical vapor deposition), PACVD (plasma-activated chemical vapor deposition) or similar processes. In all of these processes a plasma is produced between the workpiece and an electrode through an electrical discharge using direct current, alternating current or high frequency. In patent DE 33 22 341 C2 of the same applicant, a plasma production method with pulsed plasma discharge is described, wherein the electrical energy is supplied pulse-by-pulse, and the discharge pulses have specific pulse shapes.

It is a common feature of all plasma processes that the process is performed continuously or in steps at the respective process pressure which is considered as the optimum pressure. In some cases, this approach results in a non-uniform treatment of the workpiece surface. For example, in grooves or behind ridges and pikes the plasma density reveals irregularities or shadows such that a homogeneous surface treatment is not ensured.

### SUMMARY OF THE INVENTION

It is an object of the present invention to provide a plasma process which ensures a more uniform surface treatment.

According to the invention, during the plasma surface treatment the pressure in the reactor or the partial pressure of a gas is increased at least once and subsequently decreased again. According to the invention, an increased mass transport to the surface of the workpiece is performed. A number of other plasma effects, which depend on the particle density, are made use of by periodically or aperiodically pulsing the pressure or the partial pressure of a gas in large ranges. Tests have shown that a pulsating pressure contributes to a better distribution of the plasma density across the workpiece surface. The pressure changes make discharges more difficult. This difficulty is accepted for the benefit of a more uniform surface treatment even in the case of irregular surfaces. For the purpose of changing the particle density or the pressure, different processes may be employed. The simplest method is a rapid pumping of gas out of the reactor, for example by activating a vacuum reservoir, and subsequently increasing the pressure by a pressure surge from a storage tank. For changing the pressure, pressure waves, which can be produced mechanically or by gas discharge, for example, may be used. It is further possible to abruptly inject an evaporating liquid into the reactor. The latter case provokes a temporarily increased mass transport into the reactor.

The other plasma parameters, such as voltage and current, can be changed synchronously or asynchronously with the particle density or the pressure.

The pressure changes may take place abruptly or over an extended period of time. Pressure changes occurring in the shortest possible time are preferred. A pressure change can be caused within a very short time by inflowing gas or by a pressure wave. Evacuation of the reactor by pumping requires a longer period of time. Therefore, the pressure pulses normally are not symmetrical. Rather, they frequently have a steep leading edge and a relatively flat trailing edge.

The pressure parameters pressure pattern, frequency, maximum, minimum etc. may vary from pulse to pulse. These variations are referred to as jitter.

In the plasma treatment, at least one treatment parameter can be measured, and depending on said measurement the reaction progress can be determined and the variation of the pressure can be regulated or controlled. Another alternative is to control the pressure in a purely time-dependent manner and to perform a timing.

It is further possible to vary in a regulated or controlled manner the amount or the volume flow of a reactant supplied to the reactor in the course of reaction. Further, several reactants may be fed to the reactor in a cyclic sequence.

Embodiments of the invention will now be illustrated in greater detail with reference to the drawings. It is not intended that the invention be limited to those illustrative embodiments. Rather, the scope of the invention is defined by the appended claims and the equivalents thereof.

### BRIEF DESCRIPTION OF THE DRAWINGS

FIG. 1 shows a schematic cross section through a reactor including a workpiece during plasma discharge.

FIG. 2 shows another embodiment of the reactor comprising an auxiliary electrode.

FIG. 3 shows a longitudinal section through a reactor to which several reaction gases are supplied for CVD treatment.

FIG. 4 shows a diagram of a time history of the pressure in the reactor.

FIG. 5 shows an example of a means for abruptly increasing and decreasing the pressure in a reactor.

FIG. 6 shows an example of a pressure increase by injecting a liquid, preferably for oxidizing the workpiece surface.

### DETAILED DESCRIPTION OF PREFERRED EMBODIMENTS OF THE INVENTION

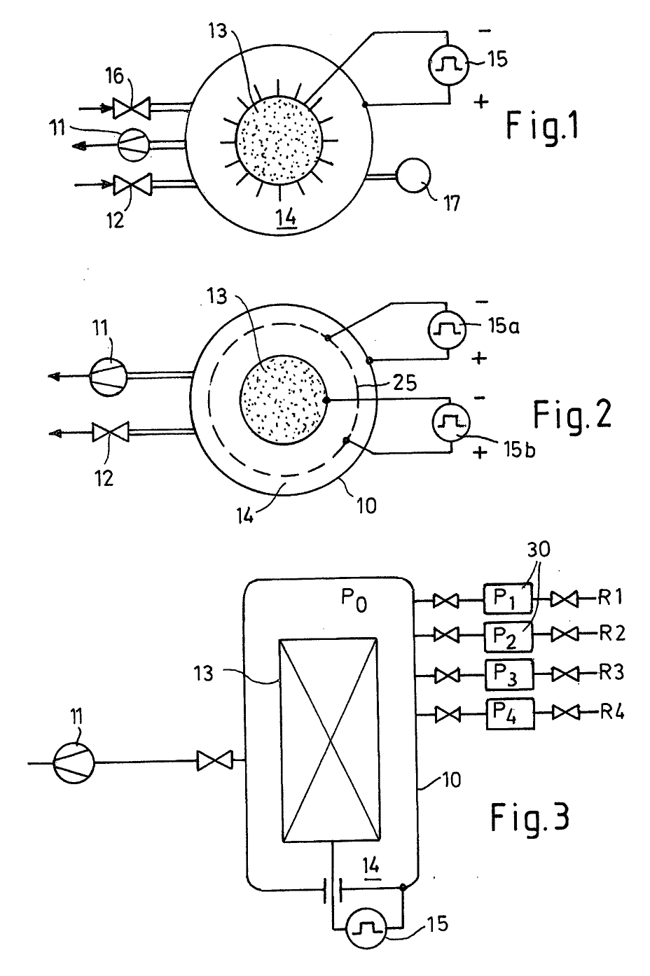

FIG. 1 shows a pressure-tight reactor 10 in which a vacuum pump 11 can generate a vacuum. A process gas can be introduced into the reactor 10 via a valve 12 for the purpose of creating an atmosphere suitable for the plasma to be produced and for causing a mass transport, with the plasma, to a workpiece.

The reactor 10 includes a workpiece 13 arranged in a reactor space 14 in an isolated manner or at a defined potential and in spaced relationship to the reactor wall. The workpiece 13 is made of a conductive material, in particular metal. The wall of the reactor 10 is also made of metal. The wall of the reactor 10 and the workpiece 13 are connected to a voltage source 15. The positive pole of the voltage source 15 is connected to the wall of the reactor 10 which defines a counter electrode for the workpiece 13. The negative pole of the voltage source is connected to the workpiece 13. The voltage source 15 is a pulsed voltage source, for example, as described in DE 33 22 341 C2. As a result of glow discharges between the reactor wall and the workpiece 13, a plasma is produced in the space 14, whereby a material transport of species of the plasma gas to the workpiece 13 takes place. In the case of a non-conductive workpiece 13, this same system can also be operated with high frequency generation.

The valve 12, via which the process gas is introduced into the reactor 10, is temporarily opened during the treatment such that more process gas is allowed to flow into the reactor 10 and the pressure in the space 14 is increased. By evacuation using the vacuum pump 11, the vessel pressure is subsequently decreased again. Thus a varying or pulsating pressure is generated in the space 14. The pressure changes may occur periodically or in any other manner. Preferably, each pulse, i.e. each temporary pressure increase, is followed by an extended pulse gap where a stationary operation at low pressure takes place. During the plasma treatment other plasma parameters, such as voltage or current, may be changed synchronously or asynchronously with the pressure.

A pressure sensor 17 measures the pressure in the space 14 and controls or regulates process parameters depending on said measurement.

The workpiece 13 may be defined by a single body or by different parts contained in a basket, for example.

Using the apparatus shown in FIG. 1, a relatively simple process, inter alia “oxidation in plasma”, can be performed. At the beginning, the workpiece 13 is positioned in the reactor 10, and the reactor 10 is tightly sealed. Then the air is pumped out of the reactor 14 until a pressure of e.g. 50 P is reached. When the plasma produced between the workpiece 13 and the counter electrode is ignited, the workpiece surface is activated. Subsequently, water is temporarily injected into the space 14 via a valve 16, wherein the pressure is increased to 50,000 P, for example, by the evaporating water and the beginning reaction. P (=Pascal) is the unit of the pressure. 1 P equals 1 N/M². 100 P equal 1 mbar or 105 P=1 bar. The plasma extinguishes at this pressure. At the end of a defined reaction time, the reaction product is pumped out of the space 14 continuously or in steps, and the plasma is ignited again, wherein the steps are selected according to the discharge requirements. By measuring the increase in reaction products, the progress of reaction can be determined, and the reaction can be controlled or regulated via suitable means. This process results in a dense and excellently adhering oxide layer on the workpiece 13.

Alternatively, the pressure can be increased linearly or in steps. Here, the water is not injected abruptly but over an extended period of time.

Another process, where the pressure can be varied according to the invention, is the plasma nitration process. Here, a nitrogen atmosphere is produced in the space 14 via the valve 12 after the air has been pumped out. The pressure of the nitrogen atmosphere is periodically or aperiodically changed. An example of the time history of the pressure P is illustrated in FIG. 4. This example shows relatively sharp pressure increases 20 each followed by a short section 21 of constant and high pressure. Said section 21 is followed by a declining section 22 where the vacuum pump 11 pumps the gas out of the space 14 until a lower pressure 23 is reached again. The electrical power is increased in the course of the treatment. This approach results in a very good plasma nitration of the workpiece surface, with any preferred treatment and shadowing of edges and grooves, which are otherwise inevitable, being prevented.

FIG. 2 shows a reactor 10 which is generally of similar configuration as the embodiment of FIG. 1, but comprises in the space 14 a hollow electrode 25 in the form of a grid basket surrounding the workpiece 13 in spaced relationship to the workpiece 13 and being arranged between the workpiece 13 and the reactor wall. A first voltage source 15a applies a voltage between the reactor wall and the grid 25. A second voltage source 15b applies a voltage between the workpiece 13 and the grid 25. Here, the pressure change is not effected by injection and evacuation but by a pressure wave produced by a discharge between the grid 25 and the surrounding reactor wall. A similar effect can be obtained by a periodical or non-periodical modulation of the discharge voltage. Here, the amplitude, the duty cycle, the pulse duration or the pulse interval can be modulated. Such pressure wave generation is possible even without the use of the grid 25 which lies at a special potential, for example by using the device shown in FIG. 1 where the voltage source 15 is modulated in a suitable manner. Further, it is possible to divide the grid 25 into individual segments and to sequentially apply said segments to one or more voltage sources. The structure referred to as grid may further comprise a more complex hollow cathode structure, e.g. a honeycomb structure.

FIG. 3 shows an embodiment for performing a CVD process. Here, TiN is deposited on steel or any other material, such as titanium, hard metal, nickel base alloy etc. In the known process it is inevitable that a certain amount of HCl, e.g. 0.5%, is included in the layer. This has a negative effect on the adhesion of the layer and the corrosion behavior.

FIG. 3 shows a device for performing the CVD process. The reactor comprises a plurality of inlets for different reactants R1,R2,R3,R4. Each reactant is introduced into the reactor 10 via a pressure controller 30 which determines a specific partial pressure P1,P2,P3,P4. In the space 14 of the reactor 10 the pressure P₀ is generated.

The device of FIG. 3 allows not only the pressure in the space 14 but also the partial pressure of the individual reactants to be specifically changed. This specific pressure change results in a cleaning of the thinly applied surface layer and substantially reduces the chlorine portion in the mentioned CVD process. Adhesion and corrosions properties are considerably improved. Further, large batches can be treated in a uniform manner.

Another embodiment relates to the generation of a multi-layer coating of titanium, boron, aluminum and further elements. Said multi-layer coating is produced by alternately introducing the metal synchronously or asynchronously with the course of the process with the aid of the device of FIG. 3.

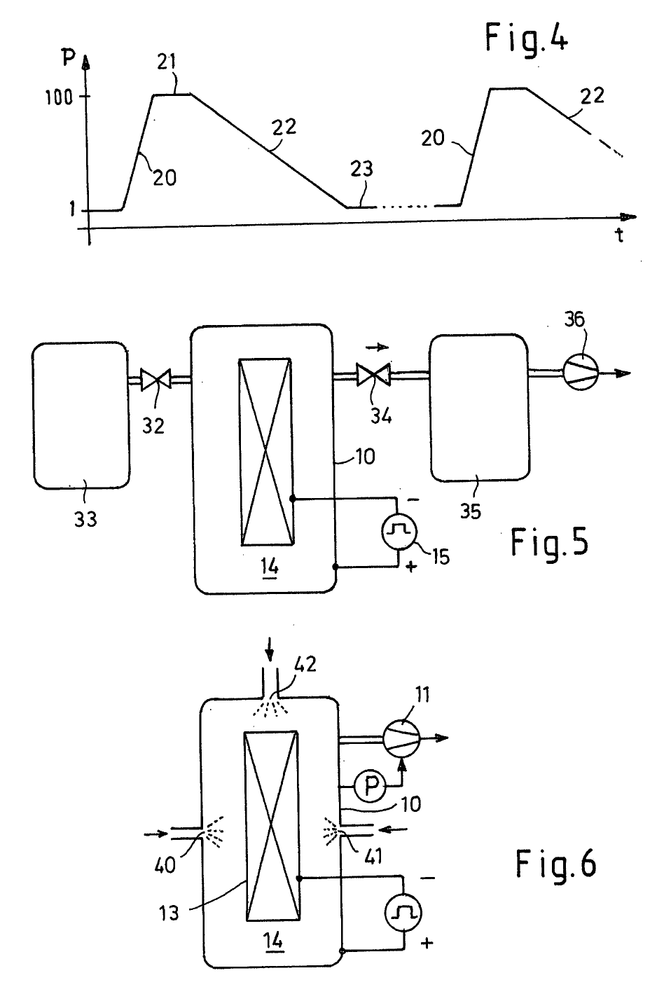

FIG. 5 shows a device wherein the reactor 10 is connected to a gas container 33 via a controllable first valve 32. Further, the reactor 10 is connected to a vacuum chamber 35 via a controllable second valve 34, in which vacuum chamber 35 a partial vacuum is produced by a vacuum pump 36. By alternately opening the valves 32 and 34 the pressure in the space 14 can be abruptly changed in the described manner.

FIG. 6 shows an example of plasma oxidation using water injected into the space 14. Here, too, a vacuum pump 11 generates a partial vacuum in the space 14. Water is abruptly injected into said vacuum via nozzles 40,41,42, whereby a pressure increase and an oxidation of the workpiece surface occur. Subsequently, the nozzles 40,41,42 are shut off again such that the vacuum pump 11 reduces the pressure in the space 14.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A plasma process for surface treatment of workpieces (13), wherein in a reactor (10) a plasma discharge between an electrode and said workpiece (13) takes place under partial vacuum conditions, wherein during the treatment the pressure in the reactor (10) or the partial pressure (P1-P4) of a gas is increased at least once and subsequently decreased again.

2. The plasma process according to claim 1, wherein the pressure is abruptly increased or decreased.

3. The plasma process according to claim 1, wherein the pressure is increased or decreased according to a predetermined function.

4. The plasma process according to claim 1, wherein the pressure changes are performed periodically.

5. The plasma process according to claim 1, wherein the increased pressure is maintained for a period of time before the pressure is decreased by evacuation.

6. The plasma process according to claim 1, wherein a low pressure is maintained for a period of time before the pressure is increased.

7. The plasma process according to claim 1, wherein the pressure is varied within a range of 1-2000 P.

8. The plasma process according to claim 1, wherein the partial pressure (P1-P4) of a reactant (R1-R4) introduced into the reactor (10) is changed.

9. The plasma process according to claim 1, wherein the pressure is periodically or aperiodically changed over a multiple of a period (jitter).

10. The plasma process according to claim 9, wherein the jitter follows a predetermined distribution function, e.g. symmetric pressure jumps related to a mean value, and/or symmetric output distribution of the plasma due to the pressure jumps.

11. The plasma process according to claim 1, wherein at least one parameter of the treatment is measured and, depending on said measurement, the reaction progress is determined and the pressure variation is regulated or controlled.

12. The plasma process according to claim 1, wherein a temporary pressure changed is performed in the reactor (10) depending on the magnitude of at least one parameter.

13. The plasma process according to claim 1, wherein in an oxidation process water is used as an oxidant, and the amount of water supplied is determined on the basis of the pressure increases caused by the reaction.

14. The plasma process according to claim 1, wherein the plasma is temporarily disrupted by force.

15. The plasma process according to claim 1, wherein the amount of at least one reactant supplied to the reactor (10) is regulatedly or controlledly varied in the course or reaction.

16. The plasma process according to claim 1, wherein several reactants (R1-R4) are supplied to the reactor (10) in a cyclic sequence.

17. The plasma process according to claim 1, wherein a plasma variation is performed by igniting one or a plurality of hollow electrodes (25).

18. The plasma process according to claim 1, wherein a plasma variation is performed by igniting one or a plurality of additional electrodes.

19. The plasma process according to claim 1, wherein a plasma variation is performed by specifically switching in or switching over a plurality of electrodes.
